(19) United States
(12) Patent Application Publication
(10) Pub. No.: US 2002/0060792 A1
(43) Pub. Date: May 23, 2002

(54) Monitoring apparatus for optical transmission systems

(75) Inventors: Per Eld Ibsen, Copenhagen N. (DK); Bjarke Rose, Allerod (DK); Michael Rasmussen, Bronshoj (DK)

Correspondence Address: Altera Law Group, LLC, Suite 100, 6500 City West Parkway, Minneapolis, MN, 55344, US

(73) Assignee: ADC Inc., Minnetonka, MN

(21) Appl. No.: 09/907,874

(22) Filed: Jul. 13, 2001

(30) Foreign Application Priority Data
Jul. 11, 2000 (DK) PA 2000 01079

(51) Int. Cl. G01J 3/18

(52) U.S. Cl. 356/328

(57) ABSTRACT

An apparatus monitors spectral information of an optical transmission system. The apparatus comprises a monolithic spectrometer and at least one transmission signal detector for producing output signals of separated transmission signal components and optical noise.

### RELATED APPLICATIONS

This application claims priority from Danish Application PA 2000 01079, filed on Jul. 11, 2001, incorporated herein by reference.

### FIELD OF THE INVENTION

The present invention relates to an apparatus for monitoring spectral information of light in an optical transmission system.

### BACKGROUND

Generally, monitoring of spectral information of light of optical transmission systems involves spectroscopy based on use of cumbersome equipment comprising mirrors, lenses, and positioning equipment. However, recently monolithic spectrometers, also called compact spectrometers, which are feasible for miniaturization, and less susceptible to misalignment, distortion, moisture, malfunction and other defects, have opened up for wider applications.

Known monolithic spectrometers are generally unilateral-type spectrometers which are constructed so that the light entrance is positioned on the same side of the light propagating body as the light exits the body. This, however, limits the use of the spectrometers to applications wherein the detection means can be allowed to occupy space between the spectrometer and the optical transmission system to be monitored An example of unilateral-type spectrometers is based on a Czerny-Turner configuration which limits the minimum size of the compact spectrometer because of the required means for collimating the incoming light onto the diffraction means. Also, the Czerny-Turner configuration requires that light entrance means and light detecting means are placed on the same side of the spectrometer body.

Known monolithic spectrometers of the transmission type spectrometers involve curved reflective faces and diffracting gratings which do not easily allow for compensation of aberrations.

Most known monolithic spectrometers are not constructed to meet mass producing requirements. Often, the required production process involves steps such as diamond turning, grinding, and polishing. These processes are generally carried out in sequential steps, and known to be very expensive.

Consequently, there is a need for an improved apparatus for monitoring spectral information of light in optical transmission systems which is compact, flexible to position with respect to the system to be monitored, allow for compensation of aberration and which can be mass produced.

U.S. Pat. No. 5,796,479 discloses an apparatus for signal monitoring of wavelength, power and signal-to-noise ratio of wavelength division multiplexed (WDM) channels in telecommunication networks which does not involve use of a monolithic spectrometer.

U.S. Pat. No. 5,026,160, Dorain et al., “Monolithic Optical Programmable Spectrograph (MOPS),” discloses a unilateral solid monolithic spectrograph having a Czerny-Turner configuration wherein the incoming light is collimated into a parallel beam of light which is directed onto a diffraction grating and wherein the diffracted beam of light is focused onto a light exit placed on the same side of the monolithic body as the light entrance. The spectrometer has a base of BK7 optical glass to which all components, such as mirrors and gratings, are affixed with optical index matching glue. Affixing the components, however, require critical alignment procedures.

International Application No. WO 97/02475, Rajic et al., “Monolithic Spectrometer and Method for Fabrication of Same”, discloses another compact spectrometer utilizing the Czerny-Turner configuration. The spectrometer is a single body of translucent material with positioned surfaces for transmission, reflection, and spectral analysis of light rays. In this configuration, the mirrors and the grating are fabricated in the single body of material, and consequently the critical alignment steps can be avoided.

U.S. Pat. No. 5,159,404, Bittner, “Diode Array Spectrometer”, and Company Product Information No 79-802-e, Carl Zeiss Jena, “MMS Spectral Sensors”, disclose a compact spectrometer where the grating and the focusing mirror is combined in a single element. This makes it possible to construct a very compact spectrometer. However, stray light generated by imperfect gratings cannot simply be suppressed, and the light entrance means and light detecting means are both placed on the same side of the spectrometer.

International Application No. WO 96/05487, Ridyard and Shrewsbury, “Radiation detector”, disclose a monolithic transmission spectrometer for UV detection in which a curved reflective face and a planar diffraction grating focus light from the entrance aperture means onto the radiation detector means. This configuration relies on a fixed order of the optical elements of focusing and then diffracting the light which makes it difficult if not impossible to easily compensate or avoid aberrations, in particular chromatic aberration. In addition because the diffracted light is under a large solid angle of the detector, stray light originated from imperfections in the grating cannot easily be suppressed.

All these prior art spectrometers are constructed from a solid block of transparent material (e.g., glass). The production process used is not applicable to mass production, because it is based on diamond turning, grinding and polishing. Furthermore, it has neither been indicated nor suggested to design spectrometers having planar-like structures which are more suited for mass production.

European Application No. EP 0 942 266 A1, H. Teichmann, “Spektrometer” discloses a compact spectrometer which is manufactured by use of replication techniques. This spectrometer is a unilateral spectrometer based on the Czerny-Turner configuration which has the disadvantages mentioned above.

### SUMMARY OF THE INVENTION

In one aspect, it is an object of the present invention to provide an improved apparatus for monitoring spectral information in optical transmission systems. In particular, it is an object to provide an apparatus which is compact and which can be flexibly positioned with respect to the optical transmission system to be monitored.

Also, it is an object of the present invention to provide such an apparatus which allows for compensation or reduction of aberration, in particular chromatic aberration.

Further, it is an object of the present invention to provide such an apparatus which allow for mass production thereof.

Further objects will appear from the description of the invention and its preferred embodiments.

According to one aspect of the invention, there is provided an apparatus for monitoring spectral information of light in an optical transmission system comprising:

(a) a spectrometer for receiving transmission signals from the system and separating the received transmission signals into components according to wavelengths, and

(b) at least one transmission signal detecting means for producing output signals of the separated transmission signal components and/or of optical noise;

said spectrometer comprising at least one transparent body having a front side and a back side;

said front side including:

an entrance surface having positioned in or near thereof at least one entrance aperture means for receiving transmission signal from the system, and

at least one reflecting surface; and

said back side including:

at least one other reflecting surface for reflecting transmission signals received from said at least one entrance aperture means to said at least one reflecting surface of the front side, and

an exit surface; said exit surface being arranged in a mutual relationship with said at least one transmission signal detecting means; said detecting means being positioned in or near thereof, or positioned at a distance therefrom, for detecting the reflected transmission signal from said at least one reflecting surface of the front side;

said at least one other reflecting surface of the back side, said at least one reflecting surface of the front side, or both, having at least one diffractive optical element and/or at least one focusing means;

said at least one diffractive element and said at least one focusing means being arranged so that the transmitted transmission signal is diffracted before being focused; and

said at least one transparent body being transparent to the transmission signal from the system, said other reflecting surface of the back side, and said reflecting surface of the front side.

Such an apparatus is compact. Further, the apparatus allows monitoring of some or all of the following parameters: spectral information of the transmission signal, wavelength, intensity of each component, presence or absence of transmission signal in the system, and signal-to-noise ratios.

Also, in the apparatus, the arrangement of the at least one diffractive element and the at least one focusing means so that the transmitted transmission signal is diffracted before being focused ensures that compensation or reduction of aberration, in particular chromatic aberration, can easily be obtained.

Compensation or reduction of aberration can be obtained in any suitable manner involving aberration correcting means to correct for aberration under or after the focusing process.

In a preferred embodiment, the apparatus further comprises aberration correcting means.

In a particularly preferred embodiment, the aberration correcting means comprises at least one aspheric focusing means whereby the wavelength dependent reflection by the aspheric focusing means corrects the diffracted transmission signal of various wavelengths to the desired focus.

In another particularly preferred embodiment, the aberration correcting means comprises tilting a planar exit surface or providing an aspheric exit surface whereby the diffracted transmission signal focused by the focusing means is refracted to the desired focus.

In still another particularly preferred embodiment, the aberration correcting means comprises a combination of the at least one aspheric focusing means and the tilted exit surface whereby the aberration compensation or reduction can be made more effective.

Further, according to the invention, the at least one transmission signal detecting means are separated from the entrance aperture means whereby the apparatus can be positioned in a flexible manner with respect to the optical transmission system to be monitored. That is, the apparatus can be positioned very close to one or more systems, e.g. in form of one or more connecting optical fibers.

In many monitoring applications of optical transmission systems it is desired to have a large resolution of the spectrometer. This can be achieved by providing a long transmission signal path in the spectrometer between the entrance aperture means and detecting means.

In a preferred embodiment, the front side includes at least one further reflecting surface; and the said back side includes at least one further reflecting surface; said further reflecting surfaces being arranged to reflect transmission signal more times before being received by the at least one focusing means, the at least one diffractive means, or both whereby the transmission signal path can be increased and consequently the resolution can be increased.

The transmission signal from the optical transmission system to be monitored enters the spectrometer through an entrance aperture means. The aperture means serves to achieve a suitable resolution of the spectrometer.

Preferably the entrance aperture means comprises any suitable entrance aperture which provides reception of the transmission signal from the optical transmission system, not limiting examples being a rectangular slit, a pinhole, an optical fiber end face.

The entrance aperture means may comprise one or more entrance apertures.

In a preferred embodiment, the at least one transparent body comprises several entrance apertures for monitoring spectral information from several optical transmission systems.

The entrance aperture means can include suitable optical fiber connectors for connecting the spectrometer to the optical transmission systems either as removable or fixed spectrometers.

In a preferred embodiment, the transmission signal is provided by an optical fiber pigtailed to the spectrometer. In yet another preferred embodiment the spectrometer comprises a fiber optical connector, in which the user easily can connect the other part of the patch cable. Typical examples of suitable connecter types are FC/PC fiber optical connectors.

In another preferred embodiment, the entrance aperture means further comprises a wavelength bandpass filter whereby it is achieved that the spectrometer only analyzes a desired wavelength bandwidth of transmission signals, which is particularly useful in order to optimize the signal-to-noise ratio.

The at least one diffractive optical element is preferably planar or aspheric whereby it can easily be adapted to said at least one reflecting surfaces of the front and back sides depending on their particular function.

In another preferred embodiment, the diffractive optical element is a blazed grating whereby an improved efficiency of the spectrometer is achieved, said efficiency being defined as the amount of transmission signal distributed across the detecting means compared to the amount of transmission signal entering the entrance aperture means.

The at least one focusing means is preferably an aspheric surface, whereby it is achieved that the optics design of a compact spectrometer can be realized with fewer aberrations. In this regard, the term “aspheric surface” is known in the art, see e.g. ZEMAX, Optical Design Program, User's Guide Version 7.0, Focus Software, Inc., Tucson, Ariz. (1998) p. 13-4. We note that a spherical surface, which is commonly used in many standard lenses, is a specie of an aspheric surface.

The term “aberrations” is intended to designate the various forms of aberration, e.g. spherical and chromatic aberration, known in the art, e.g., see E. Hecht, “Optics,” Addison-Welsey, 1987, Section 6.3.

The transmission signal detecting means comprises any detecting means which is suitable for monitoring the desired spectral information of light in optical transmission systems, including optical transmission signal as well as optical noise.

The transmission signal detecting means include but are not limited to means for detecting presence or absence of optical transmission signal and/or noise. The transmission signals can be continuous, alternating, and/or in form of pulses. It can have any suitable wavelength including transmission signals in the infra-red or near infra-red region of the electromagnetic spectrum. Typical wavelengths are 1300-1600 nm.

The transmission signal detecting means further include means for detecting transmission signals of multiple wavelengths, or bands of wavelength, e.g. array detectors comprising a plurality of pixels each of which is able to detect and produce an electrical signal in response to the signal it receives.

In a particularly preferred embodiment the transmission signal detecting means consists of an array detector comprising both pixels for detecting transmission signals and for optical noise wherein pixels for detecting noise are positioned interspaced between spatially separated pixels for detecting transmission signals. Transmission signal detecting means of this kind are disclosed in U.S. Pat. No. 5,796,479, the content of which is included herein by reference.

In another preferred embodiment the transmission signal detecting means comprises an array detector, whereby it is achieved that each element of the array detector corresponds to either a single wavelength or a narrow bandwidth of wavelengths. Hereby, simultaneous monitoring of a desired bandwidth range of wavelength including wavelengths of signal and noise can be measured simultaneously.

Control of the transmission signal detecting means, e.g. the array detector, is known in the art, see e.g. Sensors Unlimited Inc., “Maximizing the Signal-to-Noise Ratio of Integrating Detectors”, Application note No. 980002A.

The transmission signal detecting means further includes means for detecting the intensity of the transmission signal components whereby the optical transmission system can be monitored for optical losses e.g. caused by rupture of optical transmission waveguides in the system.

In special applications the transmission signal detecting means include means for detecting the state of polarisation of light of the received transmission signals.

The transmission signal detecting means can be positioned either in or near the exit surface of the transparent body of the apparatus, e.g. compact spectrometer, or it can be positioned at a distance from the exit surface. By positioning the transmission signal detecting means in or near the exit surface, a very rugged spectrometer is achieved, which is advantageous in many applications where the spectrometer might be subject to vibrations during its use. Also it is advantageous with respect to long term stability of the spectrometer.

The transmission signal detecting means may be positioned below or above the surface of the exit surface face of the back side of the transparent body. In a preferred embodiment the transmission signal detecting means is positioned below the surface of the exit surface thereby ensuring a more robust spectrometer with less sensitivity of having the components in or near the surface of exit face destroyed by external strikes or the like to the body.

In another preferred embodiment the transmission signal detection means further comprises a wavelength bandpass filter, whereby it is achieved that the transmission signal detecting means only analyzes the desired wavelength bandwidth of light which is particularly useful in order to optimize the signal-to-noise ratio.

Depending on the application, the transmission signal detecting means comprises cooled or non-cooled detectors.

Cooled detectors are used when accurate assessment of optical noise is important, whereas non-cooled detectors are used when such assessment is not required.

Non-cooled detectors are used to monitor, primarily, transmission signal parameters such as power and wavelength whereby particular simple, low cost monitors of optical transmission systems can be provided.

Accordingly, in preferred embodiments, the at least one transmission signal detecting means is cooled, or non-cooled.

In particular cases, combination of both cooled and non-cooled detectors can be applied e.g. if the detection of different wavelengths requires different detectors.

In a preferred embodiment, the transparent body is a unitary body or a composed body. Preferably the unitary or composed body is replicated in optical glass or plastic material, e.g. by embossing or molding, whereby it is possible to mass-produce e.g. a very cheap compact spectrometer.

In a preferred embodiment the unitary or composed body is replicated such that the reflective surfaces are positioned below the respective surfaces of the front side and back side thereof. This embodiment is particularly advantageous, because the final spectrometer exhibits a box shape with parallel outer surfaces.

It is particularly preferred that the transparent body is a composed body comprising a front part, a back part, and optionally an intermediate part; said front part incorporating said transmission signal entrance aperture means, said at least one diffractive optical element and/or said at least one focusing means; and said back part incorporating said exit surface, said at least one diffractive optical element and/or said at least one focusing means.

The intermediate part may be present or not depending on the application. In a preferred embodiment, said optionally intermediate part consists of a material selected from the group consisting of a low cost transparent material, a thermally stable transparent material, and a filtering material, or a combination thereof.

The parts of the composed body might be coupled by e.g. optical cement.

The unitary or composed body might also be assembled by single pieces of optical elements, e.g. replicated optical elements or glass optical elements, which are coupled with e.g. optical cement.

The transparent body is preferably covered with light absorbing material, e.g., black paint, apart from apertures necessary for light passage, e.g. the entrance aperture means and at the exit surface. The light absorbing material serves to suppress stray light, i.e. to suppress multiple scattered light inside the transparent body that adds noise to the measurements. The light absorbing material further serves to prevent ambient light to enter the spectrometer and thus add noise to the measurements. Additionally it serves to prevent light from the entrance aperture means to be guided directly to the light detection means, which is possible in a transmission spectrometer, and crucial for the measurements because this effect cannot easily be eliminated electronically.

Imperfections in the diffractive optical element are causing a substantial amount of stray light in all spectrometers. By arranging the optical elements so that light from the diffractive optical element cannot be scattered directly onto the light detecting means, inclusion of light absorbing material can eliminate or reduce this highly undesired noise source.

Preferably, the light absorbing material has an index of refraction identical to or very close to the index of refraction of the spectrometer unit, whereby reflections from the interface between said light absorbing material and said spectrometer body is minimized. Hereby it is achieved that the amount of stray light is further suppressed.

In a preferred embodiment where the transparent body is molded, the light absorbing material is also molded into said body.

In yet another preferred embodiment, the light absorbing material is coated, e.g. painted, onto said transparent body.

In another preferred embodiment where the transparent body is a composed body, light absorbing material is positioned inside the composed body, e.g. between the composed units, whereby it is possible to further suppress the amount of stray light and eliminate light scattering directly from the entrance aperture means to the light detection means, because extra sets of apertures can be included.

In a preferred embodiment, the apparatus comprises at least two spectrometer channels, e.g. a multi-channel spectrometer comprising at least two transparent bodies, each of which constitutes said channels.

The multi-channel spectrometer might be realized by positioning the spectrometer channels in parallel, but the spectrometer channels can also be placed in continuation of each other in a so-called serial spectrometer.

In a preferred embodiment where the multiple spectrometer channels are placed in parallel, the transmission signal detecting means preferably comprises an array detector with a separate array for each channel whereby a cost-effective “stack” of 2D array multi-channel spectrometers for coupling to an optical transmission system, e.g. in a multi-optical fiber arrangement is provided.

Monitoring of various optical parameters of spectral information of light in optical transmission systems is disclosed in e.g. Ditech Communications Corporation, The Role of Channel Monitoring in DWDM Networks, Application note No. MON-001; D. Y. Al-Salemeh, M. T. Fatehi, W. J. Gartner, S. Lumish, B. L. Nelseon, K. K. Raychaudhuri, “Optical Networking”, Bell Labs Technical Journal, January-March 1998, p. 39-61; and Y. Sun, A. K. Srivastava, J. Zhou, and J. W. Sulhoff, “Optical Fiber Amplifiers for WDM Optical Networks”, Bell Labs Technical Journal, January-March 1999, p. 187-206, the contents of which are incorporated herein by reference.

### BRIEF DESCRIPTION OF THE DRAWINGS

In the following, the invention is further disclosed with detailed description of preferred embodiments, reference being made to the drawings in which:

FIG. 1 shows a preferred embodiment of the present invention in which the ray-tracing simulations are illustrated.

FIG. 2 shows a preferred embodiment of the present invention in which the ray-tracing simulations are illustrated for an apparatus with multiple reflective surfaces leading to improved resolution.

FIG. 3A shows a three dimensional sketch of a preferred embodiment in which the apparatus comprises parallel front sides and back sides.

FIG. 3B shows a cross-sectional sketch of the preferred embodiment shown in FIG. 3A in which the reflecting surfaces are placed below the respective surfaces of the front side and back side.

FIG. 4 shows a three dimensional sketch of a preferred embodiment in which the apparatus is a composed body in which light absorbing material is positioned inside the composed body.

FIG. 5 shows a three dimensional sketch of a preferred embodiment in which the apparatus consists of two parallel spectrometer channels.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

The present invention is applicable to monitoring a fiber transmission system, and is believed to be particularly suited to monitoring challe wavelength and power in a wavelength division multiplexed (WDM) optical communication system. The system may also permit the monitoring of interchannel noise levels.

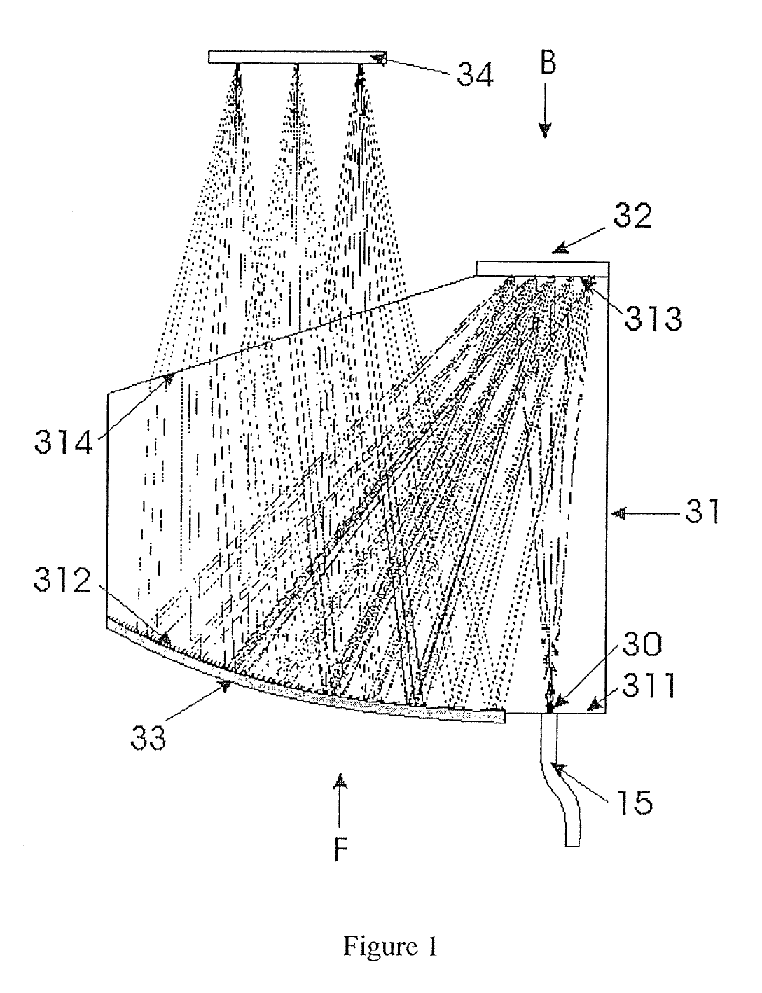

FIG. 1 shows a cross-sectional sketch of a ray-tracing simulation of a single channel including a transparent body 31 in a preferred transmission spectrometer embodiment. The transmission signal guiding means 15 (here an optical fiber connected to the optical transmission system) is positioned in front F of the transparent body 31 and is guiding transmission signal to the transmission signal entrance aperture means 30, positioned at the entrance surface 311. In this example the entrance aperture means is defined by the circular aperture of the core of the end face of the optical fiber 15. Inside the transparent body 31 the transmission signal propagates towards a reflecting surface 313 of the back side at which a diffractive optical element 32 (here a blazed grating) diffracts the transmission signal towards a reflective surface 312 of the front side, in this preferred embodiment an aspheric mirror 33. The aspheric mirror focuses the diffracted wavelengths across the plane of the transmission signal detecting means 34, in this example comprising an array detector (here a linear array detector of type SU512LX-1.7T30250 supplied by Sensors Unlimited) and placed opposite the entrance means at the back side B of the transparent body. The transmission signal detecting means is placed at a distance from the exit surface 314, which is tilted to correct for chromatic aberrations.

The array detector is configured to define pixels for transmission signals of predefined wavelength and pixels for optical noise at wavelengths therebetween.

This apparatus was used for monitoring transmission signal wavelength, power and noise, both alone and in combination.

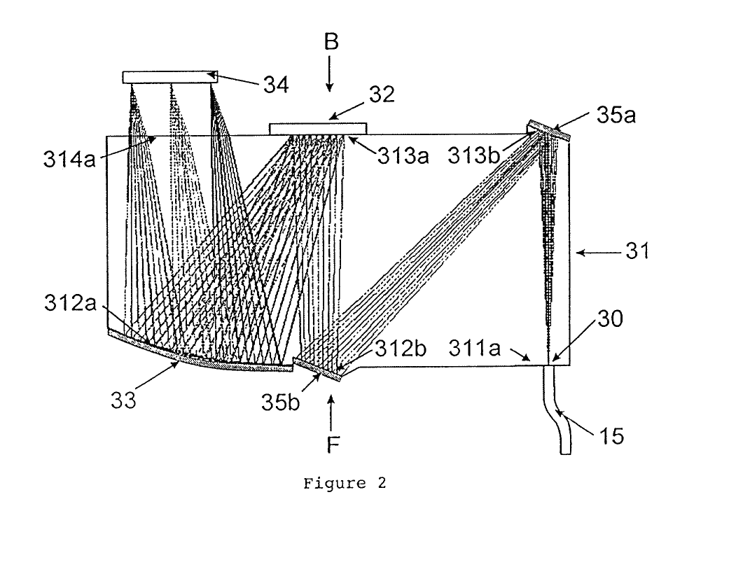

FIG. 2 shows a cross-sectional sketch of a ray-tracing simulation of a single channel including a transparent body 31 in a preferred transmission spectrometer embodiment. The transmission signal guiding means 15 (here an optical fiber connected to the optical transmission system) is positioned in front F of the transparent body 31 and is guiding transmission signal to the transmission signal entrance aperture means 30, positioned at the entrance surface 311. In this example the entrance aperture means is defined by the circular aperture of the core of the end face of the optical fiber 15. Inside the transparent body 31, the transmission signal propagates towards a further reflecting surface 313b of the back side at which a planar mirror 35a directs the transmission signal towards a further reflective surface 312b of the front side at which a planar mirror 35b directs the transmission signal towards the reflective surface 313a of the back side, at which a diffractive optical element 32 (here a blazed grating) diffracts the transmission signal towards the reflective surface 312a of the front side, in this preferred embodiment an aspheric mirror 33. The aspheric mirror 33 focuses the diffracted wavelengths across the plane of the transmission signal detecting means 34, in this example comprising an array detector and placed opposite the entrance means at the back side B of the transparent body. The transmission signal detecting means is placed at a distance from the exit surface 314a.

In this preferred embodiment the diffractive optical element 32 and the transmission signal detecting means 34 are arranged in parallel planes or coinciding planes. Also, the entrance surface 311a and the exit surface 314a are parallel.

Other preferred transmission spectrometer geometry's will be shown in the following, but will not be substantiated by ray-tracing simulations.

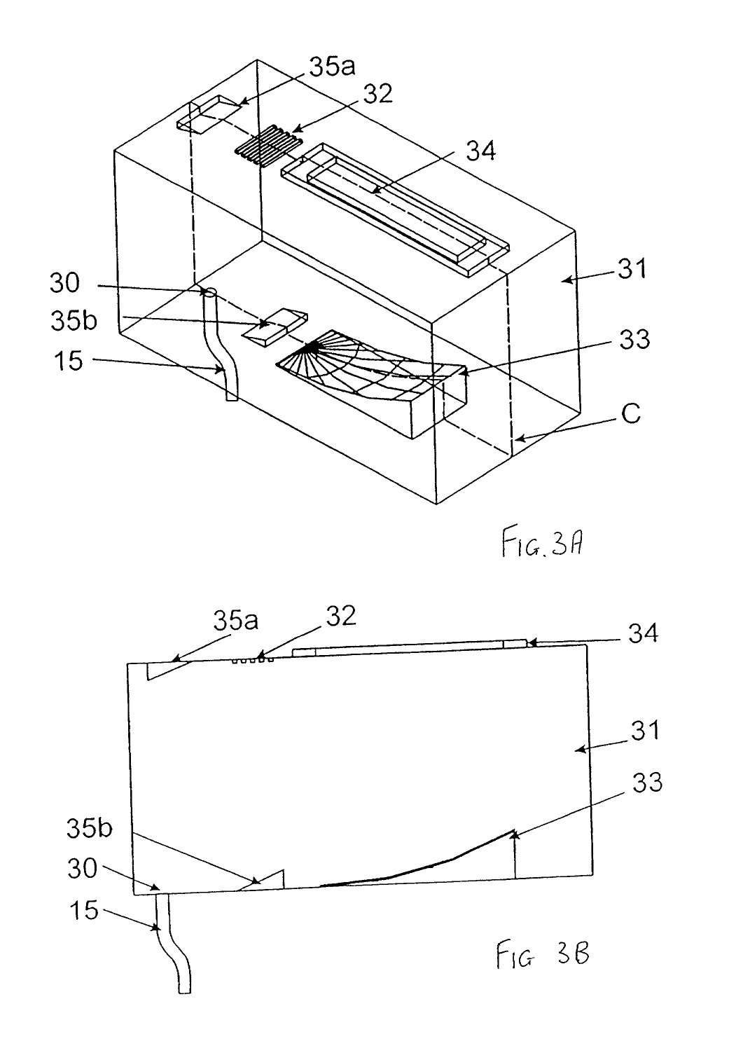

FIG. 3A shows a three dimensional sketch of a preferred embodiment in which the reflective surfaces (i.e., the planar mirrors 35a, 35b, the diffractive optical element 32, and the aspheric mirror 33) are positioned below the respective surfaces of the front side and back side. This is clearly illustrated in FIG. 3B, which shows a cross-sectional sketch taken at the plane C from FIG. 3A.

The principle of the ray-tracing simulations is illustrated in FIG. 2 with the exception that that the aspheric mirror 33 now focus the diffracted wavelengths across the detecting means 34 which is now positioned at the exit surface.

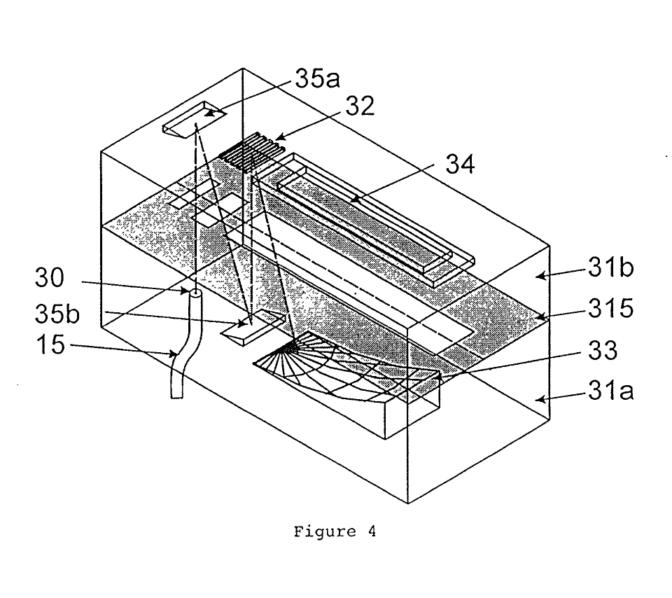

FIG. 4 shows a three dimensional sketch of a preferred embodiment in which the spectrometer body is a composed body (31a, 31b) and in which light absorbing material 315 is placed between said composed bodies. The spectrometer is similar to the transmission spectrometer illustrated in FIG. 3 and described above.

The composed body comprising a front part 31a and a back part 31b. The front part is incorporating a transmission signal entrance aperture means 30, a further planar mirror 35b, and the focusing means 33. The back part is incorporating a further planar mirror 35a, the diffractive optical element, and the exit surface.

This preferred embodiment is composed of two parts (31a, 31b).

In another preferred embodiment, the transparent composed body further comprises an intermediate part.

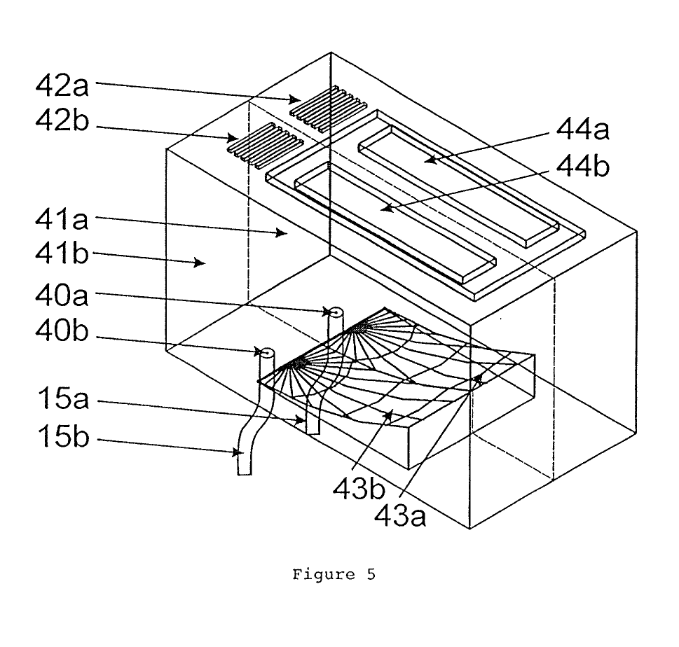

FIG. 5 shows a three dimensional sketch of a preferred embodiment that consists of two parallel spectrometer channels. In the preferred embodiment shown in FIG. 5, the dual channel spectrometer comprises a first channel 41a to monitor transmission signals from the first transmission signal guiding means 15a from an optical transmission system and a second channel 41b to monitor transmission signals from the second transmission signal guiding means 15b from the optical transmission system. The transmission signal enters each spectrometer channel through an aperture, in this example defined by the cores of end faces of the optical fibers (40a, 40b), and each channel is an independent transmission spectrometer working according to the ray-tracing simulation illustrated in FIG. 1 with the exception that that the aspheric mirrors (43a, 43b) now focus the diffracted wavelengths across the transmission signal detecting means (44a, 44b) which is now positioned at the exit surface.

The transmission signals from the first channel 41 a are focused onto the transmission signal detecting means 44a whereas the transmission signals from the second channel are focused onto the transmission signal detecting means 44b.

Preferably the transmission signal detecting means (44a, 44b) comprises a dual line sensor, said line comprising an array sensor.

Multiple channels with 2D array image sensor to provide for a cost effective solution.

As noted above, the present invention is applicable to methods and apparatus for monitoring the output from a fiber communications system. It is believed to be particularly useful for monitoring the wavelength and power of different channels in a multiple channel system, such as a wavelength division multiplexed (WDM) system. The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

We claim:

1. An apparatus for monitoring spectral information of light in an optical transmission system comprising:
a spectrometer for receiving transmission signals from the system and separating the received transmission signals into components according to wavelengths, the spectrometer including
a transparent body having a front side and a back side, the front side including
an entrance surface having at least one entrance aperture for receiving light, and
at least a first front reflecting surface, and the back side including
at least a first back reflecting surface for reflecting light received from the at least one entrance aperture to the at least one front reflecting surface, and
an exit surface,
at least one of the at least a first front reflecting surface and the at least a first back reflecting surface including a first diffractive optical element, and at least one of the at least a first front surface and the at least a first back reflecting surface including a first focusing element, the first diffractive element being arranged to receive diverging light from the at least one entrance aperture; and
a light detector unit arranged to receive light through the exit surface from the at least one reflecting surface on the front side and to generate output signals in response to light received in the spectrometer from the optical transmission system.

2. The apparatus according to claim 1, wherein a light path through the transparent body from the entrance aperture to the exit surface via the first diffractive optical element and the first focusing element is incident on an aberration correcting element.

3. The apparatus according to claim 2, wherein the first focusing element is an aspheric focusing element, the aspheric focusing element comprising the aberration correcting element.

4. The apparatus according to claim 2, wherein the aspheric correcting element includes one of a tilted exit surface and an aspheric exit surface.

5. The apparatus according to claim 1, wherein the front side further includes at least a second front reflecting surface and the back side includes at least a second back reflecting surface, the at least a second front reflecting surface and the at least a second back reflecting being arranged to reflect light propagating from the entrance aperture to the diffractive optical element.

6. The apparatus according to claim 1, wherein the first diffractive optical element and the light detector unit are arranged in parallel planes.

7. The apparatus according to claim 1, wherein the entrance surface and the exit surface are parallel.

8. The apparatus according claim 1, wherein the entrance aperture includes a rectangular slit.

9. The apparatus according to claim 1, wherein the entrance aperture includes an exit face of an optical fiber.

10. The apparatus according to claim 1, wherein the diffractive optical element is aspheric.

11. The apparatus according to claim 1, wherein the light detector unit is positioned at a selected distance from the exit surface of the transparent body.

12. The apparatus according to claim 1, wherein the transparent body is a unitary body.

13. The apparatus according to claim 1, wherein the transparent body is a composite, transparent body.

14. The apparatus according to claim 13 wherein the composite, transparent body includes at least first and second body parts, the first body part including the front side and the second body part including the back side.

15. The apparatus according to claim 14, further comprising light absorbing material disposed between the first and second body parts.

16. The apparatus according to claim 14, further comprising at least one intermediate body part between the first and second body parts.

17. The apparatus according to claim 1, wherein the transparent body is covered by light absorbing material.

18. The apparatus according to claim 17, wherein the light absorbing material has a refractive index approximately equal to a refractive index of the transparent body.

19. The apparatus according claim 17, wherein the light absorbing material is coated onto the transparent body.

20. The apparatus according to claim 17, wherein the light absorbing material is molded into the transparent body.

21. The apparatus according to claim 1, further comprising at least two spectrometer channel paths between the at least one entrance aperture and the light detector unit.

22. The apparatus according to claim 21, wherein the at least two spectrometer channel paths are parallel.

23. The apparatus according to claim 1, wherein the at least one transparent body comprises a plurality of entrance apertures defining optical paths within the spectrometer for monitoring spectral information from several optical transmission systems coupled to respective entrance apertures.

24. The apparatus according to claim 1, wherein the light detector unit includes an array detector.

25. The apparatus according to claim 1, wherein the light detector unit is cooled.

26. The apparatus according to claim 1, wherein the light detector unit is non-cooled.

27. The apparatus according to claim 24, wherein the optical transmission system is a wavelength division multiplexed optical fiber communication system.
